(19) United States
(12) Patent Application Publication
(10) Pub. No.: US 2025/0142515 A1
(43) Pub. Date: May 1, 2025

(54) LOCATION INFORMATION REPORTING IN DISAGGREGATED RADIO ACCESS NETWORK (RAN)

(71) Applicant: QUALCOMM Incorporated, San Diego, CA (US)

(72) Inventors: Naeem AKL, Bridgewater, NJ (US); Navid ABEDINI, Basking Ridge, NJ (US); Haris ZISIMOPOULOS, London (GB); Tao LUO, San Diego, CA (US)

(21) Appl. No.: 18/686,684

(22) PCT Filed: Aug. 9, 2022
(86) PCT No.: PCT/US2022/074706

§ 371 Date: Feb. 26, 2024

(30) Foreign Application Priority Data
Sep. 14, 2021 (GR) 20210100604

(51) Int. Cl. H04W 64/00

(52) U.S. Cl. CPC H04W 64/00

(57) ABSTRACT

Disclosed are techniques for communication. In an aspect, a first network node receives, from a second network node, a request for location information for a user equipment (UE) served by the first network node, and transmits, to the second network node, a location information report for the UE, the location information report including at least an identifier of a sub-cell with which the UE is associated.

### CROSS-REFERENCE TO RELATED APPLICATIONS

The present Application for Patent claims the benefit of GR application No. 20210100604, entitled “LOCATION INFORMATION REPORTING IN DISAGGREGATED RADIO ACCESS NETWORK (RAN)”, filed Sep. 14, 2021, and is a national stage application, filed under 35 U.S.C. § 371, of International Patent Application No. PCT/US2022/074706, entitled, “LOCATION INFORMATION REPORTING IN DISAGGREGATED RADIO ACCESS NETWORK (RAN)”, filed Aug. 9, 2022, both of which are assigned to the assignee hereof and are expressly incorporated herein by reference in their entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of communication performed by a first network node includes receiving, from a second network node, a request for location information for a user equipment (UE) served by the first network node; and transmitting, to the second network node, a location information report for the UE, the location information report including at least an identifier of a sub-cell with which the UE is associated.

In an aspect, a method of communication performed by a second network node includes transmitting, to a first network node, a request for location information for a user equipment (UE) served by the first network node; and receiving, from the first network node, a location information report for the UE, the location information report including at least an identifier of a sub-cell with which the UE is associated.

In an aspect, a first network node includes a memory; at least one transceiver; and at least one processor communicatively coupled to the memory and the at least one transceiver, the at least one processor configured to: receive, via the at least one transceiver, from a second network node, a request for location information for a user equipment (UE) served by the first network node; and transmit, via the at least one transceiver, to the second network node, a location information report for the UE, the location information report including at least an identifier of a sub-cell with which the UE is associated.

In an aspect, a second network node includes a memory; at least one transceiver; and at least one processor communicatively coupled to the memory and the at least one transceiver, the at least one processor configured to: transmit, via the at least one transceiver, to a first network node, a request for location information for a user equipment (UE) served by the first network node; and receive, via the at least one transceiver, from the first network node, a location information report for the UE, the location information report including at least an identifier of a sub-cell with which the UE is associated.

In an aspect, a first network node includes means for receiving, from a second network node, a request for location information for a user equipment (UE) served by the first network node; and means for transmitting, to the second network node, a location information report for the UE, the location information report including at least an identifier of a sub-cell with which the UE is associated.

In an aspect, The first network node of claim 69, wherein the one or more trigger conditions comprise: whether the UE entered or exited the one or more areas of interest.

In an aspect, a second network node includes means for transmitting, to a first network node, a request for location information for a user equipment (UE) served by the first network node; and means for receiving, from the first network node, a location information report for the UE, the location information report including at least an identifier of a sub-cell with which the UE is associated.

In an aspect, a non-transitory computer-readable medium stores computer-executable instructions that, when executed by a first network node, cause the first network node to: receive, from a second network node, a request for location information for a user equipment (UE) served by the first network node; and transmit, to the second network node, a location information report for the UE, the location information report including at least an identifier of a sub-cell with which the UE is associated.

In an aspect, a non-transitory computer-readable medium stores computer-executable instructions that, when executed by a second network node, cause the second network node to: transmit, to a first network node, a request for location information for a user equipment (UE) served by the first network node; and receive, from the first network node, a location information report for the UE, the location information report including at least an identifier of a sub-cell with which the UE is associated.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIG. 3A illustrates an example of an integrated access and backhaul (IAB) network structure, according to aspects of the disclosure.

FIG. 3B is a diagram of an example IAB resource management framework, according to aspects of the disclosure.

FIGS. 4A, 4B, and 4C are simplified block diagrams of several sample aspects of components that may be employed in a user equipment (UE), a base station, and a network entity, respectively, and configured to support communications as taught herein.

FIG. 5 is a diagram of a New Radio cell global identifier (NCGI) used to identify a cell of a base station, according to aspects of the disclosure.

FIG. 6 illustrates an example location reporting procedure, according to aspects of the disclosure.

FIG. 7 is a diagram of an example network deployment of a base station and multiple repeaters, according to aspects of the disclosure.

FIGS. 8 and 9 illustrate example methods of communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

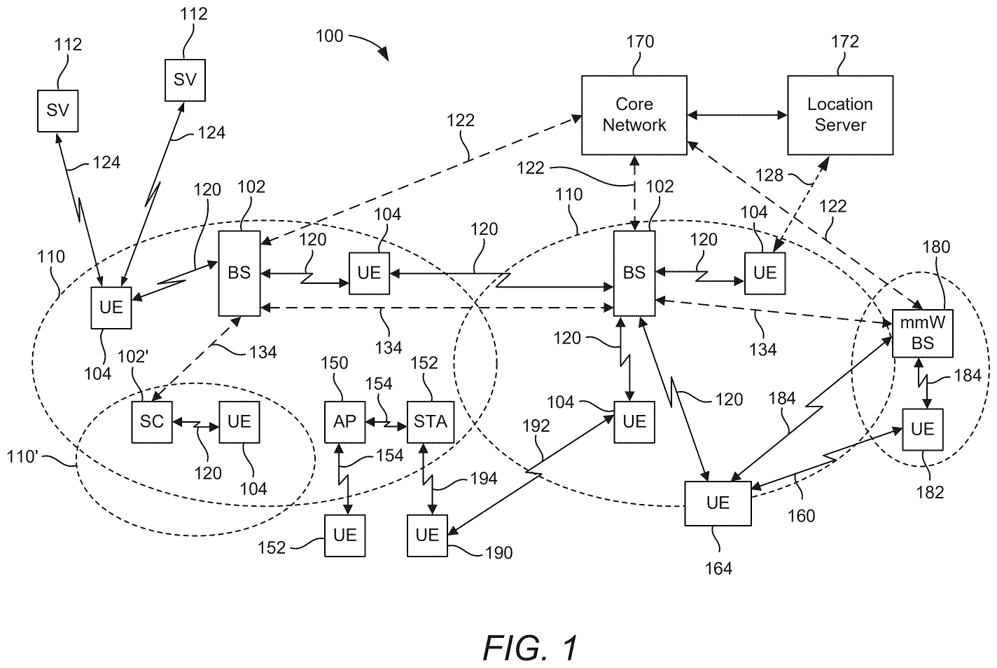

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backbaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network. 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mm W base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mm W base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (cV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

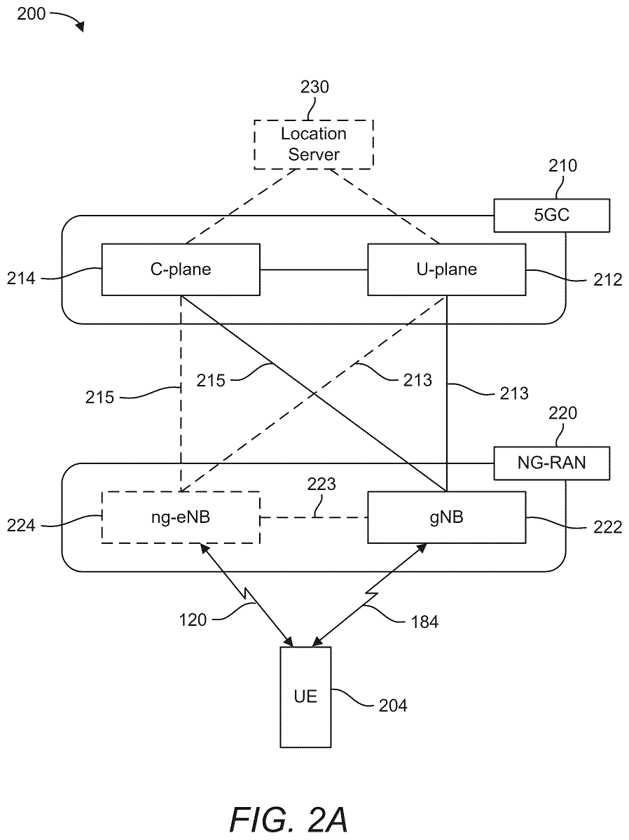

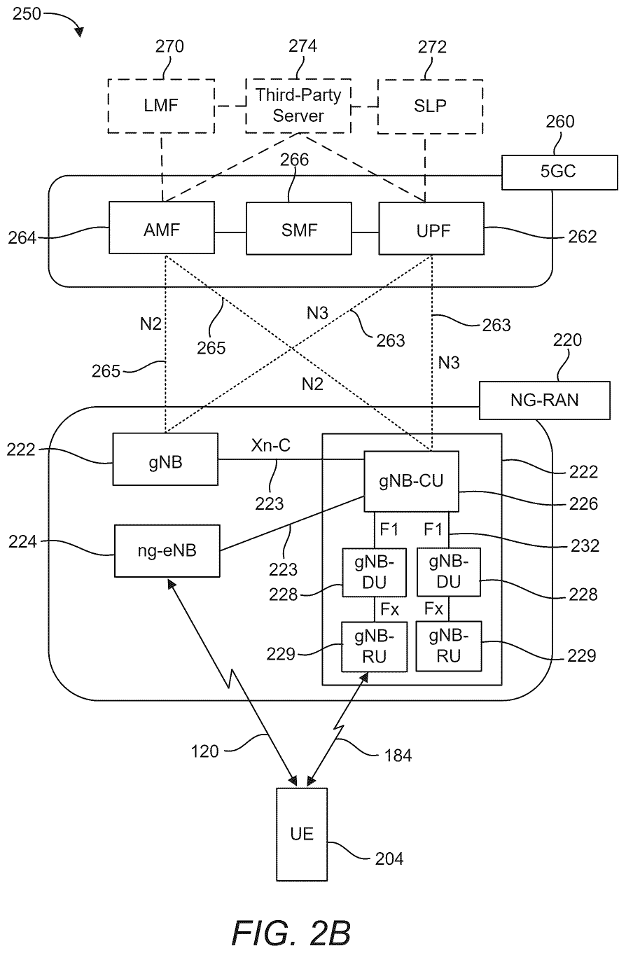

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 250. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

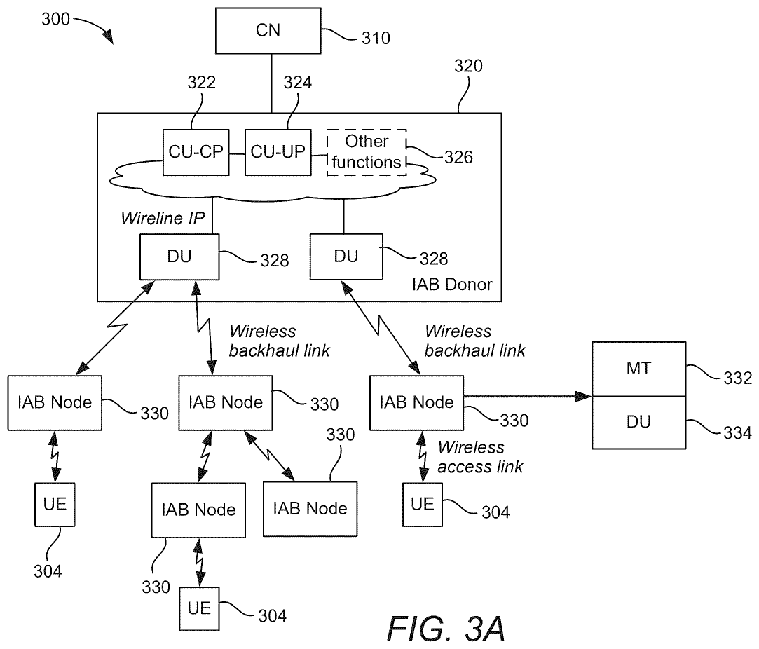

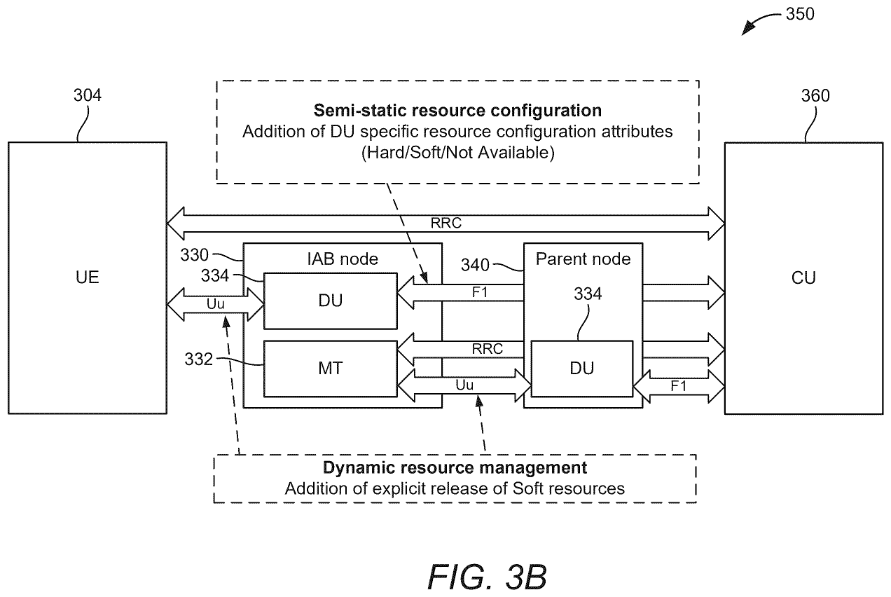

FIG. 3A illustrates an example of an integrated access and backhaul (IAB) network structure, according to aspects of the disclosure.

FIG. 3B is a diagram of an example IAB resource management framework, according to aspects of the disclosure.

FIG. 3A illustrates an example of an IAB network structure 300, according to aspects of the disclosure. The IAB network structure 300 includes a core network (CN) 310 (e.g., 5GC 210 or 260) and at least one IAB donor 320. The IAB donor 320 may be an NG-RAN node (e.g., a gNB or other network entity in the NG-RAN 220) that provides a same interface to the core network 310 as other non-IAB NG-RAN nodes (e.g. gNBs) and provides wireless backhaul functionality to downstream IAB nodes 330. The IAB donor 320 includes a central unit control plane (CU-CP) function 322, a central unit user plane (CU-UP) function 324, and other optional functions 326. These various functions are connected to one or more distributed units (DUs), also referred to as IAB donor-DUs 328 (two in the example of FIG. 3A) over wireline IP links. The DUs 328 of the IAB donor 320 support NR wireless backhaul access to one or more IAB nodes 330 using an RF interface that is typically a subset of the NR interface supported by a gNB-DU to support access by a UE. The links between the DUs 328 and the IAB nodes 330 provide backhaul connectivity over a wireless link, and thus, as shown in FIG. 3A, are referred to as “wireless backhaul links.”

An IAB node 330 includes a DU 334 (also referred to as an IAB-DU 334) that supports NR radio access from child nodes (e.g., UEs 304 and/or other IAB nodes 330) in the same way as that supported by a gNB-DU or IAB donor-DU. The IAB node 330 also includes a mobile termination (MT) 332 that accesses its parent node using NR (e.g., accesses the DU 334 of another IAB node 330 or a DU 328 of the IAB donor 320). The DU 334 of an IAB node 330 may support one or more cells of its own and appears as a normal base station to UEs 304 (e.g., any of the UEs described herein) and/or appears as an IAB donor-DU to the MTs 332 of other IAB nodes 330 connecting to it. The links between the DU 334 of a parent IAB node 330 and its child nodes (e.g., UEs 304 and/or the MTs 332 of other IAB nodes 330) provide network access over a wireless link, and thus, as shown in FIG. 3A, are referred to as “wireless access links.” Referring to FIG. 1, the small cell base station 102′ may be an IAB node 330 and the macro cell base station 102 to which it is connected may be an IAB donor 320.

Connecting an IAB node 330 to the network may use the same initial access mechanism (e.g., a random-access procedure) as a UE 304. Once connected, an IAB node 330 receives necessary configuration data from the IAB donor 320. Additional child IAB nodes 330 can connect to the network through the cell(s) created by a parent IAB node 330, thereby enabling multi-hop wireless backhauling.

FIG. 3B is a diagram of an example IAB resource management framework 350, according to aspects of the disclosure. FIG. 3B illustrates a CU 360 belonging to an IAB donor (not shown in FIG. 3B), a parent node 340, an IAB node 330, and a UE 304. The CU 360 may correspond to one or both of the CU-CP 322 and CU-UP 324 in FIG. 3A. The parent node 340 may be any IAB node 330 having a child IAB node 330. The IAB node 330 includes a DU 334 and an MT 332. The parent node 340 also includes a DU 334 and an MT 332, but for simplicity, only the DU 334 is shown.

The CU 360 is a logical node that includes the base station functions of transferring user data, mobility control, radio access network sharing, positioning, session management, and the like, except for those functions allocated exclusively to the DU(s) 328 (not shown in FIG. 3B). More specifically, the CU 360 intercepts and supports the radio resource control (RRC) and packet data convergence protocol (PDCP) layers of a base station, while the DU(s) 328 intercepts and supports the radio link control (RLC), medium access control (MAC), and physical (PHY) layers of the base station. Thus, as shown in FIG. 3B, the UE 304 and the CU 360 communicate at a control plane level via a radio resource control (RRC) protocol layer, whereas the UE 304 and the DU 334 of the IAB node 930 communicate over the Uu interface (the air interface between a UE and a base station).

Because the IAB node 330 (specifically, the MT 332) acts similar to a UE in its interaction with the parent node 340 (specifically, the DU 334), the MT 332 of the IAB node 330 can also communicate with the CU 360 via the RRC layer and with the DU 334 of the parent node 340 over the Uu interface (because the link between the IAB node 330 and its parent node 340 is a wireless backhaul link). However, the respective DUs 334 of the IAB node 330 and parent node 340 communicate with the CU 360 over a wireless front-haul interface referred to as the “F1-AP” or “F1” interface. The DUs 334 obtain an IP address for F1-C (F1 control plane) and F1-U (F1 user plane) traffic from the CU 360. Any F1 traffic (F1-C and F1-U) from the DU 334 of an IAB node 330 terminates at the CU 360.

In the IAB resource management framework 350, resource and slot format definitions remain compatible with legacy UEs (e.g., non-NR UEs or older NR UEs). The focus is on the half-duplex constraint and time division multiplexing (TDM) operation between the DU 334 and the MT 332. Another difference is that additional resource attributes are defined for, and visible to, the DU 334 for semi-static resource configuration. Specifically, the additional attributes include Hard, Soft, and Not Available designations. A “Hard” designation indicates that the resource can be assumed to be used by the DU 334. A “Not Available” designation indicates that the resource cannot be used by the DU 334 (e.g., with some exceptions for cell-specific signals). A “Soft” designation indicates that by default the resource cannot be used by the DU 334. Rather, it can be assumed to be used only if (a) the parent node 340 explicitly releases it, or (b) if the IAB node 330 can determine that it does not impact the operation of its MT 332. Thus, as shown in FIG. 3B, the dynamic resource management between the IAB node 330 and the UE 304 includes the additional functionality/signaling of explicit releases for Soft resources received by an MT 332 from its parent DU 334. In some designs, Soft resources of an IAB node are dynamically controlled by its parent node (e.g., explicit indication via downlink control information (DCI) format 2_5, or implicit indication without impact to an MT 332).

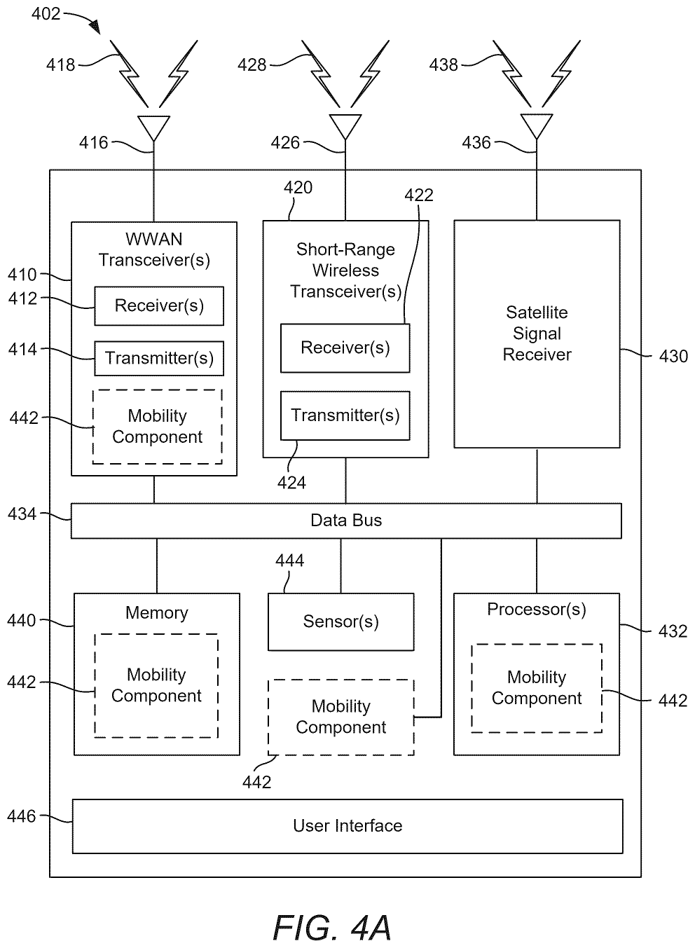

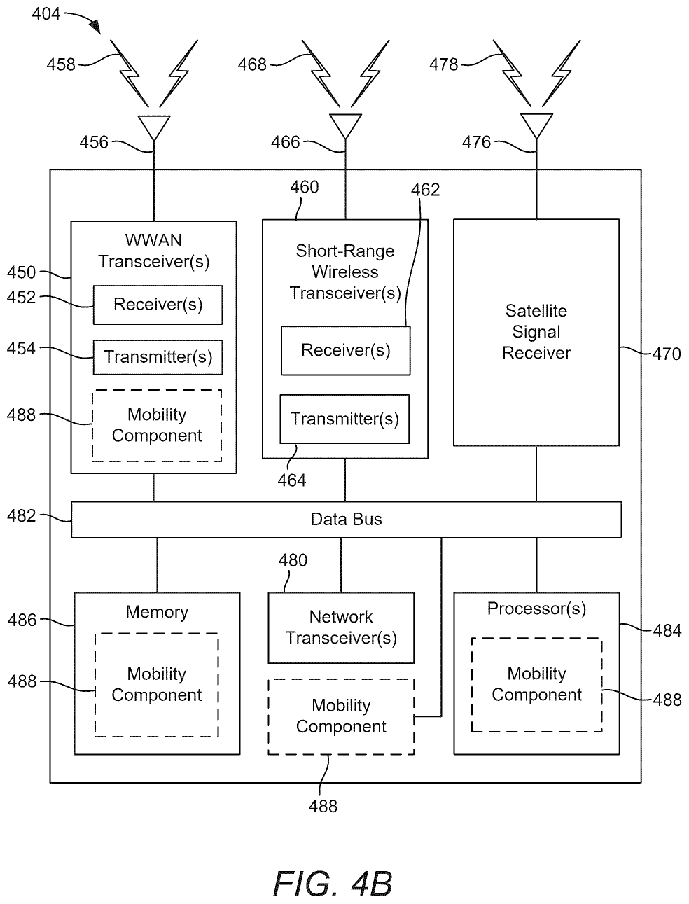

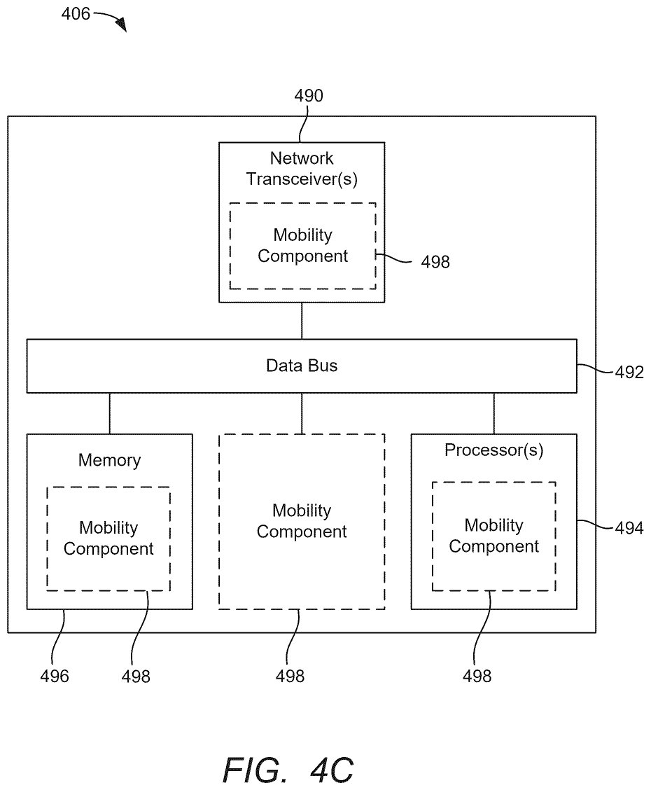

FIGS. 4A, 4B, and 4C illustrate several example components (represented by corresponding blocks) that may be incorporated into a UE 402 (which may correspond to any of the UEs described herein), a base station 404 (which may correspond to any of the base stations described herein), and a network entity 406 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the file transmission operations as taught herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 402 and the base station 404 each include one or more wireless wide area network (WWAN) transceivers 410 and 450, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 410 and 450 may each be connected to one or more antennas 416 and 456, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 410 and 450 may be variously configured for transmitting and encoding signals 418 and 458 (e.g., messages, indications, information, and so on), respectively, and, conversely, for receiving and decoding signals 418 and 458 (e.g., messages, indications, information, pilots, and so on), respectively, in accordance with the designated RAT. Specifically, the WWAN transceivers 410 and 450 include one or more transmitters 414 and 454, respectively, for transmitting and encoding signals 418 and 458, respectively, and one or more receivers 412 and 452, respectively, for receiving and decoding signals 418 and 458, respectively.

The UE 402 and the base station 404 each also include, at least in some cases, one or more short-range wireless transceivers 420 and 460, respectively. The short-range wireless transceivers 420 and 460 may be connected to one or more antennas 426 and 466, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®), Z-Wave®, PC5, dedicated short-range communications (DSRC), wireless access for vehicular environments (WAVE), near-field communication (NFC), etc.) over a wireless communication medium of interest. The short-range wireless transceivers 420 and 460 may be variously configured for transmitting and encoding signals 428 and 468 (e.g., messages, indications, information, and so on), respectively, and, conversely, for receiving and decoding signals 428 and 468 (e.g., messages, indications, information, pilots, and so on), respectively, in accordance with the designated RAT. Specifically, the short-range wireless transceivers 420 and 460 include one or more transmitters 424 and 464, respectively, for transmitting and encoding signals 428 and 468, respectively, and one or more receivers 422 and 462, respectively, for receiving and decoding signals 428 and 468, respectively. As specific examples, the short-range wireless transceivers 420 and 460 may be WiFi transceivers, Bluetooth® transceivers, Zigbee® and/or Z-Wave® transceivers, NFC transceivers, or vehicle-to-vehicle (V2V) and/or vehicle-to-everything (V2X) transceivers.

The UE 402 and the base station 404 also include, at least in some cases, satellite signal receivers 430 and 470. The satellite signal receivers 430 and 470 may be connected to one or more antennas 436 and 476, respectively, and may provide means for receiving and/or measuring satellite positioning/communication signals 438 and 478, respectively. Where the satellite signal receivers 430 and 470 are satellite positioning system receivers, the satellite positioning/communication signals 438 and 478 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 430 and 470 are non-terrestrial network (NTN) receivers, the satellite positioning/communication signals 438 and 478 may be communication signals (e.g., carrying control and/or user data) originating from a 5G network. The satellite signal receivers 430 and 470 may comprise any suitable hardware and/or software for receiving and processing satellite positioning/communication signals 438 and 478, respectively. The satellite signal receivers 430 and 470 may request information and operations as appropriate from the other systems, and, at least in some cases, perform calculations to determine locations of the UE 402 and the base station 404, respectively, using measurements obtained by any suitable satellite positioning system algorithm.

The base station 404 and the network entity 406 each include one or more network transceivers 480 and 490, respectively, providing means for communicating (e.g., means for transmitting, means for receiving, etc.) with other network entities (e.g., other base stations 404, other network entities 406). For example, the base station 404 may employ the one or more network transceivers 480 to communicate with other base stations 404 or network entities 406 over one or more wired or wireless backhaul links. As another example, the network entity 406 may employ the one or more network transceivers 490 to communicate with one or more base station 404 over one or more wired or wireless backhaul links, or with other network entities 406 over one or more wired or wireless core network interfaces.

A transceiver may be configured to communicate over a wired or wireless link. A transceiver (whether a wired transceiver or a wireless transceiver) includes transmitter circuitry (e.g., transmitters 414, 424, 454, 464) and receiver circuitry (e.g., receivers 412, 422, 452, 462). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 480 and 490 in some implementations) may be coupled to one or more wired network interface ports. Wireless transmitter circuitry (e.g., transmitters 414, 424, 454, 464) may include or be coupled to a plurality of antennas (e.g., antennas 416, 426, 456, 466), such as an antenna array, that permits the respective apparatus (e.g., UE 402, base station 404) to perform transmit “beamforming,” as described herein. Similarly, wireless receiver circuitry (e.g., receivers 412, 422, 452, 462) may include or be coupled to a plurality of antennas (e.g., antennas 416, 426, 456, 466), such as an antenna array, that permits the respective apparatus (e.g., UE 402, base station 404) to perform receive beamforming, as described herein. In an aspect, the transmitter circuitry and receiver circuitry may share the same plurality of antennas (e.g., antennas 416, 426, 456, 466), such that the respective apparatus can only receive or transmit at a given time, not both at the same time. A wireless transceiver (e.g., WWAN transceivers 410 and 450, short-range wireless transceivers 420 and 460) may also include a network listen module (NLM) or the like for performing various measurements.

As used herein, the various wireless transceivers (e.g., transceivers 410, 420, 450, and 460, and network transceivers 480 and 490 in some implementations) and wired transceivers (e.g., network transceivers 480 and 490 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 402) and a base station (e.g., base station 404) will generally relate to signaling via a wireless transceiver.

The UE 402, the base station 404, and the network entity 406 also include other components that may be used in conjunction with the operations as disclosed herein. The UE 402, the base station 404, and the network entity 406 include one or more processors 432, 484, and 494, respectively, for providing functionality relating to, for example, wireless communication, and for providing other processing functionality. The processors 432, 484, and 494 may therefore provide means for processing, such as means for determining, means for calculating, means for receiving, means for transmitting, means for indicating, etc. In an aspect, the processors 432, 484, and 494 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 402, the base station 404, and the network entity 406 include memory circuitry implementing memories 440, 486, and 496 (e.g., each including a memory device), respectively, for maintaining information (e.g., information indicative of reserved resources, thresholds, parameters, and so on). The memories 440, 486, and 496 may therefore provide means for storing, means for retrieving, means for maintaining, etc. In some cases, the UE 402, the base station 404, and the network entity 406 may include mobility component 442, 488, and 498, respectively. The mobility component 442, 488, and 498 may be hardware circuits that are part of or coupled to the processors 432, 484, and 494, respectively, that, when executed, cause the UE 402, the base station 404, and the network entity 406 to perform the functionality described herein. In other aspects, the mobility component 442, 488, and 498 may be external to the processors 432, 484, and 494 (e.g., part of a modem processing system, integrated with another processing system, etc.). Alternatively, the mobility component 442, 488, and 498 may be memory modules stored in the memories 440, 486, and 496, respectively, that, when executed by the processors 432, 484, and 494 (or a modem processing system, another processing system, etc.), cause the UE 402, the base station 404, and the network entity 406 to perform the functionality described herein. FIG. 4A illustrates possible locations of the mobility component 442, which may be, for example, part of the one or more WWAN transceivers 410, the memory 440, the one or more processors 432, or any combination thereof, or may be a standalone component. FIG. 4B illustrates possible locations of the mobility component 488, which may be, for example, part of the one or more WWAN transceivers 450, the memory 486, the one or more processors 484, or any combination thereof, or may be a standalone component. FIG. 4C illustrates possible locations of the mobility component 498, which may be, for example, part of the one or more network transceivers 490, the memory 496, the one or more processors 494, or any combination thereof, or may be a standalone component.

The UE 402 may include one or more sensors 444 coupled to the one or more processors 432 to provide means for sensing or detecting movement and/or orientation information that is independent of motion data derived from signals received by the one or more WWAN transceivers 410, the one or more short-range wireless transceivers 420, and/or the satellite signal receiver 430. By way of example, the sensor(s) 444 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 444 may include a plurality of different types of devices and combine their outputs in order to provide motion information. For example, the sensor(s) 444 may use a combination of a multi-axis accelerometer and orientation sensors to provide the ability to compute positions in two-dimensional (2D) and/or three-dimensional (3D) coordinate systems.

In addition, the UE 402 includes a user interface 446 providing means for providing indications (e.g., audible and/or visual indications) to a user and/or for receiving user input (e.g., upon user actuation of a sensing device such a keypad, a touch screen, a microphone, and so on). Although not shown, the base station 404 and the network entity 406 may also include user interfaces.

Referring to the one or more processors 484 in more detail, in the downlink, IP packets from the network entity 406 may be provided to the processor 484. The one or more processors 484 may implement functionality for an RRC layer, a packet data convergence protocol (PDCP) layer, a radio link control (RLC) layer, and a medium access control (MAC) layer. The one or more processors 484 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and bandover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 454 and the receiver 452 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 454 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 402. Each spatial stream may then be provided to one or more different antennas 456. The transmitter 454 may modulate an RF carrier with a respective spatial stream for transmission.

At the UE 402, the receiver 412 receives a signal through its respective antenna(s) 416. The receiver 412 recovers information modulated onto an RF carrier and provides the information to the one or more processors 432. The transmitter 414 and the receiver 412 implement Layer-1 functionality associated with various signal processing functions. The receiver 412 may perform spatial processing on the information to recover any spatial streams destined for the UE 402. If multiple spatial streams are destined for the UE 402, they may be combined by the receiver 412 into a single OFDM symbol stream. The receiver 412 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 404. These soft decisions may be based on channel estimates computed by a channel estimator. The soft decisions are then decoded and de-interleaved to recover the data and control signals that were originally transmitted by the base station 404 on the physical channel. The data and control signals are then provided to the one or more processors 432, which implements Layer-3 (L3) and Layer-2 (L2) functionality.

In the uplink, the one or more processors 432 provides demultiplexing between transport and logical channels, packet reassembly, deciphering, header decompression, and control signal processing to recover IP packets from the core network. The one or more processors 432 are also responsible for error detection.

Similar to the functionality described in connection with the downlink transmission by the base station 404, the one or more processors 432 provides RRC layer functionality associated with system information (e.g., MIB, SIBs) acquisition, RRC connections, and measurement reporting; PDCP layer functionality associated with header compression/decompression, and security (cipbering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 404 may be used by the transmitter 414 to select the appropriate coding and modulation schemes, and to facilitate spatial processing. The spatial streams generated by the transmitter 414 may be provided to different antenna(s) 416. The transmitter 414 may modulate an RF carrier with a respective spatial stream for transmission.

The uplink transmission is processed at the base station 404 in a manner similar to that described in connection with the receiver function at the UE 402. The receiver 452 receives a signal through its respective antenna(s) 456. The receiver 452 recovers information modulated onto an RF carrier and provides the information to the one or more processors 484.

In the uplink, the one or more processors 484 provides demultiplexing between transport and logical channels, packet reassembly, deciphering, header decompression, control signal processing to recover IP packets from the UE 402. IP packets from the one or more processors 484 may be provided to the core network. The one or more processors 484 are also responsible for error detection.

For convenience, the UE 402, the base station 404, and/or the network entity 406 are shown in FIGS. 4A, 4B, and 4C as including various components that may be configured according to the various examples described herein. It will be appreciated, however, that the illustrated components may have different functionality in different designs. In particular, various components in FIGS. 4A to 4C are optional in alternative configurations and the various aspects include configurations that may vary due to design choice, costs, use of the device, or other considerations. For example, in case of FIG. 4A, a particular implementation of UE 402 may omit the WWAN transceiver(s) 410 (e.g., a wearable device or tablet computer or PC or laptop may have Wi-Fi and/or Bluetooth capability without cellular capability), or may omit the short-range wireless transceiver(s) 420 (e.g., cellular-only, etc.), or may omit the satellite signal receiver 430, or may omit the sensor(s) 444, and so on. In another example, in case of FIG. 4B, a particular implementation of the base station 404 may omit the WWAN transceiver(s) 450 (e.g., a Wi-Fi “hotspot” access point without cellular capability), or may omit the short-range wireless transceiver(s) 460 (e.g., cellular-only, etc.), or may omit the satellite receiver 470, and so on. For brevity, illustration of the various alternative configurations is not provided herein, but would be readily understandable to one skilled in the art.

The various components of the UE 402, the base station 404, and the network entity 406 may be communicatively coupled to each other over data buses 434, 482, and 492, respectively. In an aspect, the data buses 434, 482, and 492 may form, or be part of, a communication interface of the UE 402, the base station 404, and the network entity 406, respectively. For example, where different logical entities are embodied in the same device (e.g., gNB and location server functionality incorporated into the same base station 404), the data buses 434, 482, and 492 may provide communication between them.

The components of FIGS. 4A, 4B, and 4C may be implemented in various ways. In some implementations, the components of FIGS. 4A, 4B, and 4C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 410 to 446 may be implemented by processor and memory component(s) of the UE 402 (e.g., by execution of appropriate code and/or by appropriate configuration of processor components). Similarly, some or all of the functionality represented by blocks 450 to 488 may be implemented by processor and memory component(s) of the base station 404 (e.g., by execution of appropriate code and/or by appropriate configuration of processor components). Also, some or all of the functionality represented by blocks 490 to 498 may be implemented by processor and memory component(s) of the network entity 406 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 402, base station 404, network entity 406, etc., such as the processors 432, 484, 494, the transceivers 410, 420, 450, and 460, the memories 440, 486, and 496, the mobility component 442, 488, and 498, etc.

In some designs, the network entity 406 may be implemented as a core network component. In other designs, the network entity 406 may be distinct from a network operator or operation of the cellular network infrastructure (e.g., NG RAN 220 and/or 5GC 210/260). For example, the network entity 406 may be a component of a private network that may be configured to communicate with the UE 402 via the base station 404 or independently from the base station 404 (e.g., over a non-cellular communication link, such as WiFi).

In an aspect, the UE 402 and/or the base station 404 may be an IAB node (e.g., IAB node 330). In that case, the UE 402 and/or the base station 404 include network access functionality to which UEs or the MTs of other IAB nodes can connect and backhaul functionality that behaves like a UE towards its parent node (e.g., the DU of another IAB node or an IAB donor). Thus, the one or more WWAN transceivers 410 and/or 450 and/or the one or more short-range wireless transceivers 420 and/or 460 may provide wireless network access to one or more UEs and/or one or more MTs of other IAB nodes. Where the base station 404 is an IAB node, the one or more WWAN transceivers 450, the one or more short-range wireless transceivers 460, and/or the one or more network transceivers 480 may behave like a UE towards the base station's 404 parent node.

Note that although an IAB node comprises a DU and an MT, and both the DU and MT need their own transmit and receive capabilities, the actual hardware component(s) providing the DU and the MT functionality may be separate or may be shared. For example, the one or more WWAN transceivers 450 may provide DU functionality and the one or more network transceivers 480 may provide MT functionality, or one WWAN transceiver 450 may provide DU functionality and another WWAN transceiver 450 may provide MT functionality. Alternatively, the same WWAN transceiver 450 may provide both DU and MT functionality. As such, the distinction between the DU and the MT may be a logical partition rather than a physical one.

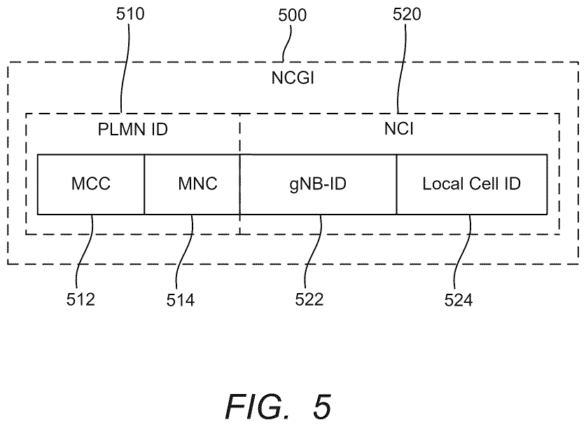

FIG. 5 is a diagram of a New Radio cell global identifier (NCGI) 500 used to identify a cell of a base station, according to aspects of the disclosure. For example, an NCGI 500 may be used as an identifier of a cell of an IAB-donor DU (e.g., IAB-donor DU 328) or an IAB-node DU (e.g., IAB DU 334). An NCGI 500 consists of a 24-bit PLMN ID 510 and a 36-bit NR cell ID (NCI) 520. A PLMN ID 510 consists of a 12-bit mobile country code (MCC) 512 and a 12-bit mobile network code (MNC) 514. An NCI 520 consists of a gNB-ID 522 in the 22 to 32 leftmost bits of the NCI 520 and a local cell ID 524 in the remaining bits.

The gNB-ID 522 is unique to a gNB and is therefore common to all of the cells (at IAB-donor DUs and IAB-node DUs) served by the gNB (with one IAB-donor CU/CU-CP). Equivalently, the combination of a PLMN ID 510 and a gNB-ID 522 globally identify a gNB. Note that the present disclosure applies to both access and IAB-networks. As such, IAB-DUs/donor-DUs are referred to as gNB-DUs. Similarly, IAB-donor-CUs, CU-CPs, and CU-UPs are referred to as gNB-CUs, gNB-CU-CPs, gNB-CU-Ups, respectively.

A specific cell of a base station (e.g., gNB) is also identified by a physical cell identifier (PCI), which may be included in the local cell ID 524. Note that a PCI is independent of an NOGI. Currently, there are a total of 1008 PCI values supported for a 5G system. A PCI can be reused by multiple geographically separated cells in a network. Cells with the same PCI can be distinguished from each other by their unique NCGI (e.g., NCGI 500). A PCI is carried by the primary synchronization signal (PSS) and secondary synchronization signal (SSS) in an SSB block broadcasted by a cell.

A cell's PCI may be used to determine the scrambling sequence of various physical signals and/or channels. For example, for the physical broadcast channel (PBCH), the physical downlink control channel (PDCCH) CoreSet0, and cell-specific physical downlink shared channel (PDSCH) transmission, only the PCI can be used as the scrambling seed. For other channels, other configured scrambling seeds can be used besides the PCI.

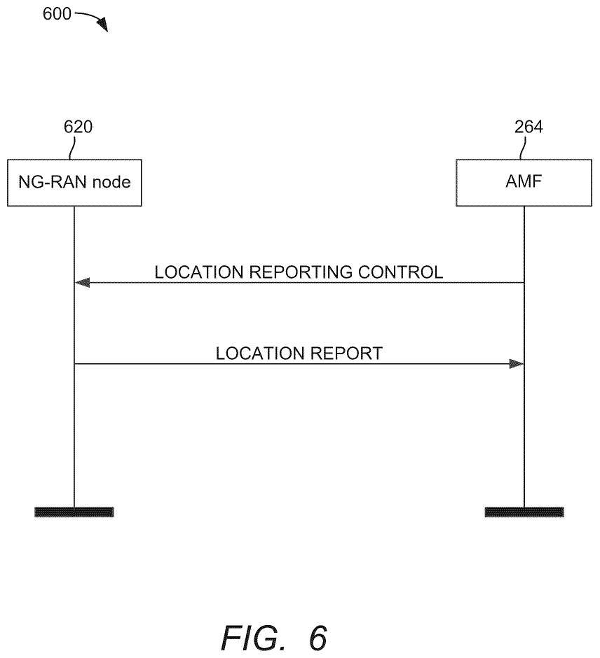

FIG. 6 illustrates an example location reporting procedure 600, according to aspects of the disclosure. The NG-RAN (e.g., NG-RAN 220) supports location reporting for the services that require accurate cell identification (e.g., emergency services, lawful intercept, charging, etc.) or for the UE mobility (e.g., handover) event notification service subscribed to the AMF 264 by other network functions (NFs). The purpose of a location reporting procedure 600 is to provide a UE's current location, a UE's last known location with timestamp, or a UE's presence in an area of interest to the AMF 264. The location reporting procedure 600 may be used by the AMF 264 when the target UE is in a CM-CONNECTED state. The location reporting procedure 600 uses UE-associated signalling.

As shown in FIG. 6, an AMF 264 initiates a location reporting procedure 600 by sending a LOCATION REPORTING CONTROL message to an NG-RAN node 620 (e.g., a gNB 222, an ng-eNB 224). On receipt of the LOCATION REPORTING CONTROL message, the NG-RAN node 620 performs the requested location reporting control action for the UE (not shown). A “Location Reporting Request Type” information element (IE) in the LOCATION REPORTING CONTROL message indicates to the NG-RAN node 620 whether (1) to report directly, (2) to report upon change of serving cell, (3) to report UE presence in the area of interest, (4) to stop reporting at change of serving cell, (5) to stop reporting UE presence in the area of interest, or (6) to cancel location reporting for the UE. If the “Area Of Interest List” IE is included in the “Location Reporting Request Type” IE in the LOCATION REPORTING CONTROL message, the NG-RAN node 620 stores this information and uses it to track the UE's presence in the area of interest.

If the “Additional Location Information” IE is included in the LOCATION REPORTING CONTROL message and set to “Include PSCell” then, if dual connectivity is activated, the NG-RAN node 620 includes the current primary secondary cell (PSCell) in the report. If a report upon change of serving cell is requested, the NG-RAN node 620 provides the report also whenever the UB changes the PSCell, and when dual connectivity is activated. If reporting upon change of serving cell is requested, the NG-RAN node 620 sends a report immediately and sends a report whenever the UE's location changes.

In response to the LOCATION REPORTING CONTROL message, the NG-RAN node 620 sends a LOCATION REPORT message to the AMF 264. The LOCATION REPORT message may be used as a response to the LOCATION REPORTING CONTROL message and includes the information requested by the LOCATION REPORTING CONTROL message.

During handover (i.e., UE mobility), location reporting related information of the source NG-RAN node 620 is transferred to the target NG-RAN node 620. A “User Location Information” IE is used to provide the location information of the UE. A “User Location Information” IE includes an NCGI field, a Tracking Area Identifier (TAI) field, an Age of Location field, a PSCell Information field, and a Network Identifier (NID) field.

In location reporting by an NG-RAN node 620 to an AMF 264, the granularity of the UE's location information is the UE's CGI (e.g., NCGI 500). However, the corresponding PCI's coverage area may be extensively expanded by the deployment of repeaters, transmission points (TPs), reception points (RPs), transmission-reception points (TRPs), remote radio heads (RRHs), and reflectors (e.g., reconfigurable intelligent surfaces (RIS)). In addition, there may be single-hop (e.g., from gNB to repeater to UE) and multi-hop (e.g., from gNB to first repeater to second repeater to UE) deployments. Further, repeaters may be mobile or stationarity.

A cellular repeater is used to improve network connectivity. A repeater commonly includes a donor antenna that receives downlink signals from nearby base stations and a rebroadcast antenna that transmits the downlink signals to one or more UEs. On the uplink, the rebroadcast antenna receives uplink signals from the one or more UEs and the donor antenna transmits the signals to the nearby base stations. Repeater communication can increase throughput, data rate, and cellular coverage, and is especially beneficial due to its ability to increase the diversity gain in a fading environment.

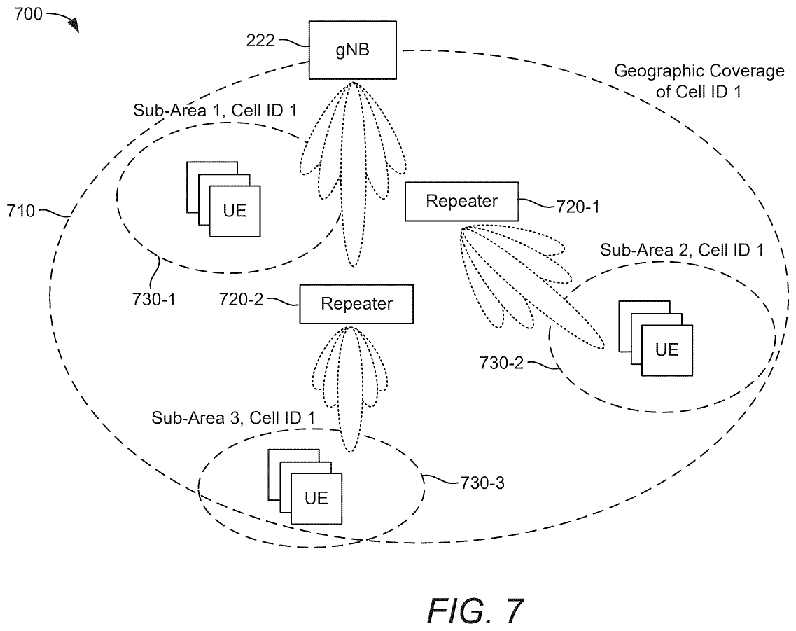

FIG. 7 is a diagram 700 of an example network deployment of a base station and multiple repeaters, according to aspects of the disclosure. As shown in FIG. 7, a cell of a gNB 222 has a geographic coverage area 710. The cell is identified by a PCI, denoted “Cell ID 1” in FIG. 7. In the example of FIG. 7, there are two repeaters 720-1 and 720-2 within the geographic coverage area 710. The gNB 222 is directly serving UEs in a first sub-area 730-1 of the cell's geographic coverage area 710 (labeled “Sub-Area 1”), the first repeater 720-1 is serving UEs in a second sub-area 730-2 of the cell's geographic coverage area 710 (labeled “Sub-Area 2”), and the second repeater 720-2 is serving UEs in a third sub-area 730-3 of the cell's geographic coverage area 710 (labeled “Sub-Area 3”). A sub-area 730 of a cell may also be referred to as a “cell portion.” A sub-area/cell portion may be a geographic area within the coverage of a cell served by a TRP, a repeater, a remote radio head, or the like associated with the base station (e.g., gNB 222), such as sub-areas 730-2 and 730-3. A sub-area/cell portion may alternatively be a geographic area within the coverage of a cell that is served by a set of beams of the base station in a particular direction, such as sub-area 730-1. For example, where a TRP corresponds to an antenna panel of a base station, sub-area 730-1 may be the coverage area of a TRP of the gNB 222. As shown in FIG. 7, although there are different sub-areas 730, each sub-area 730 has the same PCI (specifically, Cell ID 1).

A cell's PCI may not provide sufficiently granular location information. For example, with reference to FIG. 7, a UE in the second sub-area 730-2 will have the same PCI as a UE in the third sub-area 730-3, even though they are served by different repeaters 720. As such, in the example of FIG. 7, there is currently no way for the AMF 264 to know if a UE is served directly by the gNB 222, the first repeater 720-1, or the second repeater 720-2. Thus, where a UE needs to be located based on its CGI (e.g., for emergency services, lawful intercept, etc.), the AMF 264 may not be able to do so with sufficient accuracy (e.g., the accuracy set by regulatory bodies for different scenarios, such as emergency services, lawful intercept, etc.).

Accordingly, the present disclosure provides techniques for enhancing the granularity of the location information reported to the AMF 264 to sub-cell granularity (e.g., sub-PCI granularity). Sub-cell granularity will help to meet different regulatory requirements and improve support for emergency services, lawful intercept, commercial services, charging for services, etc.

In various aspects, a first network node (e.g., a gNB 222) receives a request (e.g., a LOCATION REPORTING CONTROL message) from a second network node (e.g., an AMF 264) for location information of a UE served by the first network node. The first network node returns location information for the UE to the second network node (e.g., in a LOCATION REPORT message), where the location information has sub-cell granularity, that is, an identifier of a sub-cell with which the UE is associated. The sub-cell identifier may be (1) a cell portion ID of a cell portion (e.g. a sub-area 730) within a cell associated with the target UE, (2) an identifier of a TRP serving the target UE, or (3) an identifier of a repeater (e.g., a repeater 720) serving the target UE.

The request from the second network node may indicate the granularity of the location information to be reported. The first network node then provides the location information with sub-cell granularity to the second node based on the request. For example, the request may indicate whether the request is for a cell portion ID, a TRP ID, or a repeater ID associated with the target UE. The first network node may also include time information associated with the location information in the response.

In addition to the identifier, the first network node may provide other information about the serving TRP, the repeater, or the cell portion to the second node. That information may include the associated PCI, NOGI, absolute radio-frequency channel number (ARFCN), positioning reference signal (PRS) configuration (PRS are reference signals specifically designed to be used for positioning purposes), SSB information, system frame number (SFN) initialization time, spatial (beam) direction information, geographical coordinates, or any combination thereof.

In various aspects, the first network node may provide, and/or the second network node may request, the TRP ID, repeater ID, or cell portion ID in a UE-associated manner or a non-UE associated manner.

In various aspects, the second network node may configure area(s) of interest and/or trigger condition(s) as a function of TRPs, repeaters, and/or cell portions. The report of location information by the first network node would then be based on the UE entering or exiting an area of interest or a trigger condition being satisfied. For example, one trigger may be to report sub-cell location information when a UE attaches to or detaches from a TRP or repeater. Another trigger may be to report sub-cell location information when a UE is served by one or none of a group of TRPs and/or repeaters. Yet another trigger may be when a UE enters or exits a cell portion.

In various aspects, the first network node may report the location information periodically. Whether the first network node reports location information periodically and/or the periodicity may be configured by the second network node.

In various aspects, the first network node may be a gNB-DU (e.g., DU 334) and the second network node may be a gNB-CU (e.g., a CU 360). The gNB-CU may query the gNB-DU for UE-to-TRP/repeater/cell portion ID association(s). In response, the gNB-DU may provide the gNB-CU with the requested UE-to-TRP/repeater/cell portion ID association(s).

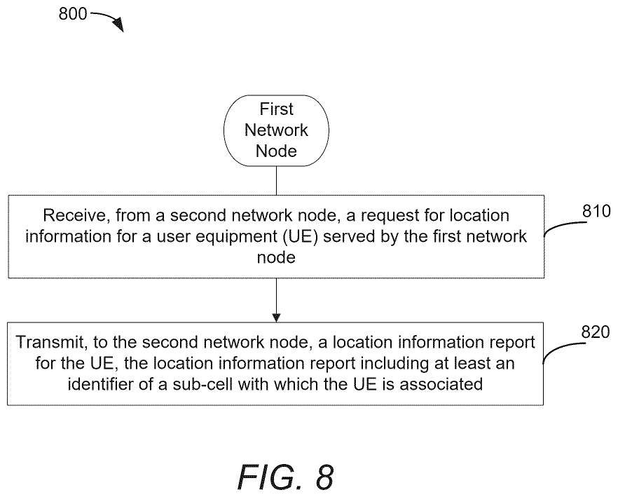

FIG. 8 illustrates an example method 800 of communication, according to aspects of the disclosure. In an aspect, method 800 may be performed by a first network node (e.g., a gNB 222).

At 810, the first network node receives, from a second network node (e.g., AMF 264), a request (e.g., a LOCATION REPORTING CONTROL message) for location information for a UE (e.g., UE 204) served by the first network node. In an aspect, operation 810 may be performed by the one or more WWAN transceivers 450, the one or more network transceivers 480, the one or more processors 484, memory 486, and/or mobility component 488, any or all of which may be considered means for performing this operation.

At 820, the first network node transmits, to the second network node, a location information report (e.g., a LOCATION REPORT message) for the UE, the location information report including at least an identifier of a sub-cell with which the UE is associated. In an aspect, operation 820 may be performed by the one or more WWAN transceivers 450, the one or more network transceivers 480, the one or more processors 484, memory 486, and/or mobility component 488, any or all of which may be considered means for performing this operation.

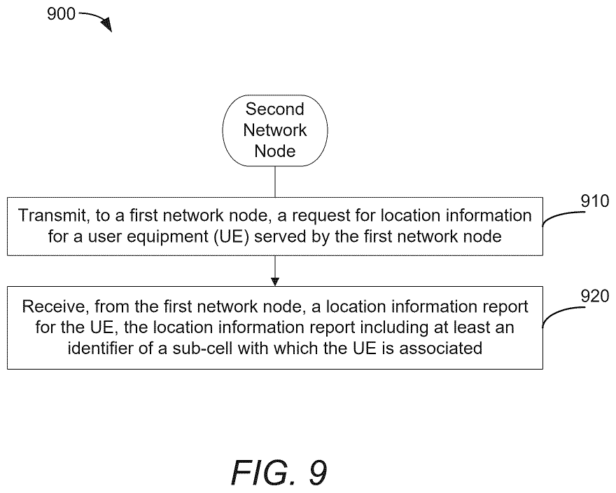

FIG. 9 illustrates an example method 900 of communication, according to aspects of the disclosure. In an aspect, method 900 may be performed by a second network node (e.g., an AMF 264).

At 910, the second network node transmits, to a first network node (e.g., a gNB 222), a request (e.g., a LOCATION REPORTING CONTROL message) for location information for a UE (e.g., UE 204) served by the first network node. In an aspect, operation 910 may be performed by the one or more network transceivers 490, the one or more processors 494, memory 496, and/or mobility component 498, any or all of which may be considered means for performing this operation.

At 920, the second network node receives, from the first network node, a location information report (e.g., a LOCATION REPORT message) for the UE, the location information report including at least an identifier of a sub-cell with which the UE is associated. In an aspect, operation 920 may be performed by the one or more network transceivers 490, the one or more processors 494, memory 496, and/or mobility component 498, any or all of which may be considered means for performing this operation.

As will be appreciated, a technical advantage of the methods 800 and 900 is finer granularity of UE location reporting, leading to improved support for emergency services, lawful intercept, commercial services, charging for services, etc.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an insulator and a conductor). Furthermore, it is also intended that aspects of a clause can be included in any other independent clause, even if the clause is not directly dependent on the independent clause.

Implementation examples are described in the following numbered clauses:

Clause 1. A method of communication performed by a first network node, comprising: receiving, from a second network node, a request for location information for a user equipment (UE) served by the first network node; and transmitting, to the second network node, a location information report for the UE, the location information report including at least an identifier of a sub-cell with which the UE is associated.

Clause 2. The method of clause 1, wherein the identifier of the sub-cell comprises: an identifier of a cell portion within a cell associated with the UE, an identifier of a transmission-reception point (TRP) serving the UE, or an identifier of a repeater serving the UE.

Clause 3, The method of any of clauses 1 to 2, wherein the request for location information indicates a requested sub-cell level of granularity, the requested sub-cell level of granularity comprising: a cell portion within a cell associated with the UE, a TRP serving the UE, or a repeater serving the UE.

Clause 4. The method of any of clauses 1 to 3, wherein the location information report includes time information associated with the identifier of the sub-cell.

Clause 5. The method of any of clauses 1 to 4, wherein the location information report further includes: a physical cell identifier (PCI) associated with the identifier of the sub-cell, a New Radio cell global identifier (NCGI) associated with the identifier of the sub-cell, an absolute radio-frequency channel number (ARFCN) associated with the identifier of the sub-cell, a positioning reference signal (PRS) configuration associated with the identifier of the sub-cell, synchronization signal block (SSB) information associated with the identifier of the sub-cell, a system frame number (SFN) initialization time associated with the identifier of the sub-cell, spatial direction information associated with the identifier of the sub-cell, geographic coordinates associated with the identifier of the sub-cell, or any combination thereof.

Clause 6. The method of any of clauses 1 to 5, further comprising: receiving, from the second network node, one or more trigger conditions for transmitting the location information report.

Clause 7. The method of clause 6, wherein the one or more trigger conditions are associated with a set of TRPs, a set of repeaters, or a set of sub-cell identifiers.

Clause 8. The method of clause 7, wherein the one or more trigger conditions comprise: whether the UE attached to or detached from a TRP in the set of TRPs or a repeater in the set of repeaters, whether the UE is served by one or none of the set of TRPs or the set of repeaters, or any combination thereof.

Clause 9. The method of any of clauses 6 to 8, wherein the one or more trigger conditions are associated with one or more areas of interest associated with one or more sub-cells associated with the first network node.

Clause 10. The method of clause 9, wherein the one or more trigger conditions comprise: whether the UE entered or exited the one or more areas of interest.

Clause 11. The method of any of clauses 1 to 10, wherein the location information report is transmitted periodically.

Clause 12. The method of any of clauses 1 to 11, further comprising: receiving, from the second network node, a request for a list of sub-cells associated with the first network node.

Clause 13. The method of any of clauses 1 to 12, wherein: the first network node is a Next Generation radio access network (NG-RAN) node, and the second network node is an access and mobility management function (AMF).

Clause 14. The method of clause 13, wherein: the request is a Location Reporting Control message, and the location information report is a Location Report message.

Clause 15. The method of any of clauses 1 to 12, wherein: the first network node is a base station distributed unit (DU), and the second network node is a base station central unit (CU).

Clause 16. A method of communication performed by a second network node, comprising: transmitting, to a first network node, a request for location information for a user equipment (UE) served by the first network node; and receiving, from the first network node, a location information report for the UE, the location information report including at least an identifier of a sub-cell with which the UE is associated.

Clause 17. The method of clause 16, wherein the identifier of the sub-cell comprises: an identifier of a cell portion within a cell associated with the UE, an identifier of a transmission-reception point (TRP) serving the UE, or an identifier of a repeater serving the UE.

Clause 18. The method of any of clauses 16 to 17, wherein the request for location information indicates a requested sub-cell level of granularity, the requested sub-cell level of granularity comprising: a cell portion within a cell associated with the UE, a TRP serving the UE, or a repeater serving the UE.

Clause 19. The method of any of clauses 16 to 18, wherein the location information report includes time information associated with the identifier of the sub-cell.

Clause 20. The method of any of clauses 16 to 19, wherein the location information report further includes: a physical cell identifier (PCI) associated with the identifier of the sub-cell, a New Radio cell global identifier (NCGI) associated with the identifier of the sub-cell, an absolute radio-frequency channel number (ARFCN) associated with the identifier of the sub-cell, a positioning reference signal (PRS) configuration associated with the identifier of the sub-cell, synchronization signal block (SSB) information associated with the identifier of the sub-cell, a system frame number (SFN) initialization time associated with the identifier of the sub-cell, spatial direction information associated with the identifier of the sub-cell, geographic coordinates associated with the identifier of the sub-cell, or any combination thereof.

Clause 21. The method of any of clauses 16 to 20, further comprising: transmitting, to the first network node, one or more trigger conditions for transmitting the location information report.

Clause 22. The method of clause 21, wherein the one or more trigger conditions are associated with a set of TRPs, a set of repeaters, or a set of sub-cell identifiers.

Clause 23. The method of clause 22, wherein the one or more trigger conditions comprise: whether the UE attached to or detached from a TRP in the set of TRPs or a repeater in the set of repeaters, whether the UE is served by one or none of the set of TRPs or the set of repeaters, or any combination thereof.

Clause 24. The method of any of clauses 21 to 23, wherein the one or more trigger conditions are associated with one or more areas of interest associated with one or more sub-cells associated with the first network node.

Clause 25. The method of clause 24, wherein the one or more trigger conditions comprise: whether the UE entered or exited the one or more areas of interest.

Clause 26. The method of any of clauses 16 to 25, wherein the location information report is received periodically.

Clause 27. The method of any of clauses 16 to 26, further comprising: transmitting, to the first network node, a request for a list of sub-cells associated with the first network node.

Clause 28. The method of any of clauses 16 to 27, wherein: the first network node is a Next Generation radio access network (NG-RAN) node, and the second network node is an access and mobility management function (AMF).

Clause 29. The method of clause 28, wherein: the request is a Location Reporting Control message, and the location information report is a Location Report message.

Clause 30. The method of any of clauses 16 to 27, wherein: the first network node is a base station distributed unit (DU), and the second network node is a base station central unit (CU).

Clause 31. A first network node, comprising: a memory; at least one transceiver; and at least one processor communicatively coupled to the memory and the at least one transceiver, the at least one processor configured to: receive, via the at least one transceiver, from a second network node, a request for location information for a user equipment (UE) served by the first network node; and transmit, via the at least one transceiver, to the second network node, a location information report for the UE, the location information report including at least an identifier of a sub-cell with which the UE is associated.

Clause 32. The first network node of clause 31, wherein the identifier of the sub-cell comprises: an identifier of a cell portion within a cell associated with the UE, an identifier of a transmission-reception point (TRP) serving the UE, or an identifier of a repeater serving the UE.

Clause 33. The first network node of any of clauses 31 to 32, wherein the request for location information indicates a requested sub-cell level of granularity, the requested sub-cell level of granularity comprising: a cell portion within a cell associated with the UE, a TRP serving the UE, or a repeater serving the UE.

Clause 34. The first network node of any of clauses 31 to 33, wherein the location information report includes time information associated with the identifier of the sub-cell.

Clause 35. The first network node of any of clauses 31 to 34, wherein the location information report further includes: a physical cell identifier (PCI) associated with the identifier of the sub-cell, a New Radio cell global identifier (NCGI) associated with the identifier of the sub-cell, an absolute radio-frequency channel number (ARFCN) associated with the identifier of the sub-cell, a positioning reference signal (PRS) configuration associated with the identifier of the sub-cell, synchronization signal block (SSB) information associated with the identifier of the sub-cell, a system frame number (SFN) initialization time associated with the identifier of the sub-cell, spatial direction information associated with the identifier of the sub-cell, geographic coordinates associated with the identifier of the sub-cell, or any combination thereof.

Clause 36. The first network node of any of clauses 31 to 35, wherein the at least one processor is further configured to: receive, via the at least one transceiver, from the second network node, one or more trigger conditions for transmitting the location information report.

Clause 37. The first network node of clause 36, wherein the one or more trigger conditions are associated with a set of TRPs, a set of repeaters, or a set of sub-cell identifiers.

Clause 38. The first network node of clause 37, wherein the one or more trigger conditions comprise: whether the UE attached to or detached from a TRP in the set of TRPs or a repeater in the set of repeaters, whether the UE is served by one or none of the set of TRPs or the set of repeaters, or any combination thereof.

Clause 39. The first network node of any of clauses 36 to 38, wherein the one or more trigger conditions are associated with one or more areas of interest associated with one or more sub-cells associated with the first network node.

Clause 40. The first network node of clause 39, wherein the one or more trigger conditions comprise: whether the UE entered or exited the one or more areas of interest.

Clause 41. The first network node of any of clauses 31 to 40, wherein the location information report is transmitted periodically.

Clause 42. The first network node of any of clauses 31 to 41, wherein the at least one processor is further configured to: receive, via the at least one transceiver, from the second network node, a request for a list of sub-cells associated with the first network node.

Clause 43. The first network node of any of clauses 31 to 42, wherein: the first network node is a Next Generation radio access network (NG-RAN) node, and the second network node is an access and mobility management function (AMF).

Clause 44. The first network node of clause 43, wherein: the request is a Location Reporting Control message, and the location information report is a Location Report message.

Clause 45. The first network node of any of clauses 31 to 42, wherein: the first network node is a base station distributed unit (DU), and the second network node is a base station central unit (CU).

Clause 46. A second network node, comprising: a memory; at least one transceiver; and at least one processor communicatively coupled to the memory and the at least one transceiver, the at least one processor configured to: transmit, via the at least one transceiver, to a first network node, a request for location information for a user equipment (UE) served by the first network node; and receive, via the at least one transceiver, from the first network node, a location information report for the UE, the location information report including at least an identifier of a sub-cell with which the UE is associated.

Clause 47. The second network node of clause 46, wherein the identifier of the sub-cell comprises: an identifier of a cell portion within a cell associated with the UE, an identifier of a transmission-reception point (TRP) serving the UE, or an identifier of a repeater serving the UE.

Clause 48. The second network node of any of clauses 46 to 47, wherein the request for location information indicates a requested sub-cell level of granularity, the requested sub-cell level of granularity comprising: a cell portion within a cell associated with the UE, a TRP serving the UE, or a repeater serving the UE.

Clause 49. The second network node of any of clauses 46 to 48, wherein the location information report includes time information associated with the identifier of the sub-cell.

Clause 50. The second network node of any of clauses 46 to 49, wherein the location information report further includes: a physical cell identifier (PCI) associated with the identifier of the sub-cell, a New Radio cell global identifier (NCGI) associated with the identifier of the sub-cell, an absolute radio-frequency channel number (ARFCN) associated with the identifier of the sub-cell, a positioning reference signal (PRS) configuration associated with the identifier of the sub-cell, synchronization signal block (SSB) information associated with the identifier of the sub-cell, a system frame number (SFN) initialization time associated with the identifier of the sub-cell, spatial direction information associated with the identifier of the sub-cell, geographic coordinates associated with the identifier of the sub-cell, or any combination thereof.

Clause 51. The second network node of any of clauses 46 to 50, wherein the at least one processor is further configured to: transmit, via the at least one transceiver, to the first network node, one or more trigger conditions for transmitting the location information report.

Clause 52. The second network node of clause 51, wherein the one or more trigger conditions are associated with a set of TRPs, a set of repeaters, or a set of sub-cell identifiers.

Clause 53. The second network node of clause 52, wherein the one or more trigger conditions comprise: whether the UE attached to or detached from a TRP in the set of TRPs or a repeater in the set of repeaters, whether the UE is served by one or none of the set of TRPs or the set of repeaters, or any combination thereof.

Clause 54. The second network node of any of clauses 51 to 53, wherein the one or more trigger conditions are associated with one or more areas of interest associated with one or more sub-cells associated with the first network node.

Clause 55. The second network node of clause 54, wherein the one or more trigger conditions comprise: whether the UE entered or exited the one or more areas of interest.

Clause 56. The second network node of any of clauses 46 to 55, wherein the location information report is received periodically.

Clause 57. The second network node of any of clauses 46 to 56, wherein the at least one processor is further configured to: transmit, via the at least one transceiver, to the first network node, a request for a list of sub-cells associated with the first network node.

Clause 58. The second network node of any of clauses 46 to 57, wherein: the first network node is a Next Generation radio access network (NG-RAN) node, and the second network node is an access and mobility management function (AMF).

Clause 59. The second network node of clause 58, wherein: the request is a Location Reporting Control message, and the location information report is a Location Report message.

Clause 60. The second network node of any of clauses 46 to 57, wherein: the first network node is a base station distributed unit (DU), and the second network node is a base station central unit (CU).

Clause 61. A first network node, comprising: means for receiving, from a second network node, a request for location information for a user equipment (UE) served by the first network node; and means for transmitting, to the second network node, a location information report for the UE, the location information report including at least an identifier of a sub-cell with which the UE is associated.

Clause 62. The first network node of clause 61, wherein the identifier of the sub-cell comprises: an identifier of a cell portion within a cell associated with the UE, an identifier of a transmission-reception point (TRP) serving the UE, or an identifier of a repeater serving the UE.

Clause 63. The first network node of any of clauses 61 to 62, wherein the request for location information indicates a requested sub-cell level of granularity, the requested sub-cell level of granularity comprising: a cell portion within a cell associated with the UE, a TRP serving the UE, or a repeater serving the UE.

Clause 64. The first network node of any of clauses 61 to 63, wherein the location information report includes time information associated with the identifier of the sub-cell.

Clause 65. The first network node of any of clauses 61 to 64, wherein the location information report further includes: a physical cell identifier (PCI) associated with the identifier of the sub-cell, a New Radio cell global identifier (NCGI) associated with the identifier of the sub-cell, an absolute radio-frequency channel number (ARFCN) associated with the identifier of the sub-cell, a positioning reference signal (PRS) configuration associated with the identifier of the sub-cell, synchronization signal block (SSB) information associated with the identifier of the sub-cell, a system frame number (SFN) initialization time associated with the identifier of the sub-cell, spatial direction information associated with the identifier of the sub-cell, geographic coordinates associated with the identifier of the sub-cell, or any combination thereof.

Clause 66. The first network node of any of clauses 61 to 65, further comprising: means for receiving, from the second network node, one or more trigger conditions for transmitting the location information report.

Clause 67. The first network node of clause 66, wherein the one or more trigger conditions are associated with a set of TRPs, a set of repeaters, or a set of sub-cell identifiers.

Clause 68. The first network node of clause 67, wherein the one or more trigger conditions comprise: whether the UE attached to or detached from a TRP in the set of TRPs or a repeater in the set of repeaters, whether the UE is served by one or none of the set of TRPs or the set of repeaters, or any combination thereof.

Clause 69. The first network node of any of clauses 66 to 68, wherein the one or more trigger conditions are associated with one or more areas of interest associated with one or more sub-cells associated with the first network node.

Clause 70. The first network node of clause 69, wherein the one or more trigger conditions comprise: whether the UE entered or exited the one or more areas of interest.

Clause 71. The first network node of any of clauses 61 to 70, wherein the location information report is transmitted periodically.

Clause 72. The first network node of any of clauses 61 to 71, further comprising: means for receiving, from the second network node, a request for a list of sub-cells associated with the first network node.

Clause 73. The first network node of any of clauses 61 to 72, wherein: the first network node is a Next Generation radio access network (NG-RAN) node, and the second network node is an access and mobility management function (AMF).

Clause 74. The first network node of clause 73, wherein: the request is a Location Reporting Control message, and the location information report is a Location Report message.

Clause 75. The first network node of any of clauses 61 to 72, wherein: the first network node is a base station distributed unit (DU), and the second network node is a base station central unit (CU).

Clause 76. A second network node, comprising: means for transmitting, to a first network node, a request for location information for a user equipment (UE) served by the first network node; and means for receiving, from the first network node, a location information report for the UE, the location information report including at least an identifier of a sub-cell with which the UE is associated.

Clause 77. The second network node of clause 76, wherein the identifier of the sub-cell comprises: an identifier of a cell portion within a cell associated with the UE, an identifier of a transmission-reception point (TRP) serving the UE, or an identifier of a repeater serving the UE.

Clause 78. The second network node of any of clauses 76 to 77, wherein the request for location information indicates a requested sub-cell level of granularity, the requested sub-cell level of granularity comprising: a cell portion within a cell associated with the UE, a TRP serving the UE, or a repeater serving the UE.

Clause 79. The second network node of any of clauses 76 to 78, wherein the location information report includes time information associated with the identifier of the sub-cell.

Clause 80. The second network node of any of clauses 76 to 79, wherein the location information report further includes: a physical cell identifier (PCI) associated with the identifier of the sub-cell, a New Radio cell global identifier (NCGI) associated with the identifier of the sub-cell, an absolute radio-frequency channel number (ARFCN) associated with the identifier of the sub-cell, a positioning reference signal (PRS) configuration associated with the identifier of the sub-cell, synchronization signal block (SSB) information associated with the identifier of the sub-cell, a system frame number (SFN) initialization time associated with the identifier of the sub-cell, spatial direction information associated with the identifier of the sub-cell, geographic coordinates associated with the identifier of the sub-cell, or any combination thereof.

Clause 81. The second network node of any of clauses 76 to 80, further comprising: means for transmitting, to the first network node, one or more trigger conditions for transmitting the location information report.

Clause 82. The second network node of clause 81, wherein the one or more trigger conditions are associated with a set of TRPs, a set of repeaters, or a set of sub-cell identifiers.

Clause 83. The second network node of clause 82, wherein the one or more trigger conditions comprise: whether the UE attached to or detached from a TRP in the set of TRPs or a repeater in the set of repeaters, whether the UE is served by one or none of the set of TRPs or the set of repeaters, or any combination thereof.

Clause 84. The second network node of any of clauses 81 to 83, wherein the one or more trigger conditions are associated with one or more areas of interest associated with one or more sub-cells associated with the first network node.

Clause 85. The second network node of clause 84, wherein the one or more trigger conditions comprise: whether the UE entered or exited the one or more areas of interest.

Clause 86. The second network node of any of clauses 76 to 85, wherein the location information report is received periodically.

Clause 87. The second network node of any of clauses 76 to 86, further comprising: means for transmitting, to the first network node, a request for a list of sub-cells associated with the first network node.

Clause 88. The second network node of any of clauses 76 to 87, wherein: the first network node is a Next Generation radio access network (NG-RAN) node, and the second network node is an access and mobility management function (AMF).

Clause 89. The second network node of clause 88, wherein: the request is a Location Reporting Control message, and the location information report is a Location Report message.

Clause 90. The second network node of any of clauses 76 to 87, wherein: the first network node is a base station distributed unit (DU), and the second network node is a base station central unit (CU).

Clause 91. A non-transitory computer-readable medium storing computer-executable instructions that, when executed by a first network node, cause the first network node to: receive, from a second network node, a request for location information for a user equipment (UE) served by the first network node; and transmit, to the second network node, a location information report for the UE, the location information report including at least an identifier of a sub-cell with which the UE is associated.

Clause 92. The non-transitory computer-readable medium of clause 91, wherein the identifier of the sub-cell comprises: an identifier of a cell portion within a cell associated with the UE, an identifier of a transmission-reception point (TRP) serving the UE, or an identifier of a repeater serving the UE.

Clause 93. The non-transitory computer-readable medium of any of clauses 91 to 92, wherein the request for location information indicates a requested sub-cell level of granularity, the requested sub-cell level of granularity comprising: a cell portion within a cell associated with the UE, a TRP serving the UE, or a repeater serving the UE.

Clause 94. The non-transitory computer-readable medium of any of clauses 91 to 93, wherein the location information report includes time information associated with the identifier of the sub-cell.

Clause 95, The non-transitory computer-readable medium of any of clauses 91 to 94, wherein the location information report further includes: a physical cell identifier (PCI) associated with the identifier of the sub-cell, a New Radio cell global identifier (NCGI) associated with the identifier of the sub-cell, an absolute radio-frequency channel number (ARFCN) associated with the identifier of the sub-cell, a positioning reference signal (PRS) configuration associated with the identifier of the sub-cell, synchronization signal block (SSB) information associated with the identifier of the sub-cell, a system frame number (SFN) initialization time associated with the identifier of the sub-cell, spatial direction information associated with the identifier of the sub-cell, geographic coordinates associated with the identifier of the sub-cell, or any combination thereof.

Clause 96. The non-transitory computer-readable medium of any of clauses 91 to 95, further comprising computer-executable instructions that, when executed by the first network node, cause the first network node to: receive, from the second network node, one or more trigger conditions for transmitting the location information report.

Clause 97. The non-transitory computer-readable medium of clause 96, wherein the one or more trigger conditions are associated with a set of TRPs, a set of repeaters, or a set of sub-cell identifiers.

Clause 98. The non-transitory computer-readable medium of clause 97, wherein the one or more trigger conditions comprise: whether the UE attached to or detached from a TRP in the set of TRPs or a repeater in the set of repeaters, whether the UE is served by one or none of the set of TRPs or the set of repeaters, or any combination thereof.

Clause 99. The non-transitory computer-readable medium of any of clauses 96 to 98, wherein the one or more trigger conditions are associated with one or more areas of interest associated with one or more sub-cells associated with the first network node.

Clause 100. The non-transitory computer-readable medium of clause 99, wherein the one or more trigger conditions comprise: whether the UE entered or exited the one or more areas of interest.

Clause 101. The non-transitory computer-readable medium of any of clauses 91 to 100, wherein the location information report is transmitted periodically.

Clause 102. The non-transitory computer-readable medium of any of clauses 91 to 101, further comprising computer-executable instructions that, when executed by the first network node, cause the first network node to: receive, from the second network node, a request for a list of sub-cells associated with the first network node.

Clause 103. The non-transitory computer-readable medium of any of clauses 91 to 102, wherein: the first network node is a Next Generation radio access network (NG-RAN) node, and the second network node is an access and mobility management function (AMF).

Clause 104. The non-transitory computer-readable medium of clause 103, wherein: the request is a Location Reporting Control message, and the location information report is a Location Report message.

Clause 105. The non-transitory computer-readable medium of any of clauses 91 to 102, wherein: the first network node is a base station distributed unit (DU), and the second network node is a base station central unit (CU).

Clause 106, A non-transitory computer-readable medium storing computer-executable instructions that, when executed by a second network node, cause the second network node to: transmit, to a first network node, a request for location information for a user equipment (UE) served by the first network node; and receive, from the first network node, a location information report for the UE, the location information report including at least an identifier of a sub-cell with which the UE is associated.

Clause 107. The non-transitory computer-readable medium of clause 106, wherein the identifier of the sub-cell comprises: an identifier of a cell portion within a cell associated with the UE, an identifier of a transmission-reception point (TRP) serving the UE, or an identifier of a repeater serving the UE.

Clause 108. The non-transitory computer-readable medium of any of clauses 106 to 107, wherein the request for location information indicates a requested sub-cell level of granularity, the requested sub-cell level of granularity comprising: a cell portion within a cell associated with the UE, a TRP serving the UE, or a repeater serving the UE.

Clause 109. The non-transitory computer-readable medium of any of clauses 106 to 108, wherein the location information report includes time information associated with the identifier of the sub-cell.

Clause 110. The non-transitory computer-readable medium of any of clauses 106 to 109, wherein the location information report further includes: a physical cell identifier (PCI) associated with the identifier of the sub-cell, a New Radio cell global identifier (NCGI) associated with the identifier of the sub-cell, an absolute radio-frequency channel number (ARFCN) associated with the identifier of the sub-cell, a positioning reference signal (PRS) configuration associated with the identifier of the sub-cell, synchronization signal block (SSB) information associated with the identifier of the sub-cell, a system frame number (SFN) initialization time associated with the identifier of the sub-cell, spatial direction information associated with the identifier of the sub-cell, geographic coordinates associated with the identifier of the sub-cell, or any combination thereof.

Clause 111. The non-transitory computer-readable medium of any of clauses 106 to 110, further comprising computer-executable instructions that, when executed by the second network node, cause the second network node to: transmit, to the first network node, one or more trigger conditions for transmitting the location information report.

Clause 112. The non-transitory computer-readable medium of clause 111, wherein the one or more trigger conditions are associated with a set of TRPs, a set of repeaters, or a set of sub-cell identifiers.

Clause 113. The non-transitory computer-readable medium of clause 112, wherein the one or more trigger conditions comprise: whether the UE attached to or detached from a TRP in the set of TRPs or a repeater in the set of repeaters, whether the UE is served by one or none of the set of TRPs or the set of repeaters, or any combination thereof.

Clause 114. The non-transitory computer-readable medium of any of clauses 111 to 113, wherein the one or more trigger conditions are associated with one or more areas of interest associated with one or more sub-cells associated with the first network node.

Clause 115. The non-transitory computer-readable medium of clause 114, wherein the one or more trigger conditions comprise: whether the UE entered or exited the one or more areas of interest.

Clause 116. The non-transitory computer-readable medium of any of clauses 106 to 115, wherein the location information report is received periodically.

Clause 117. The non-transitory computer-readable medium of any of clauses 106 to 116, further comprising computer-executable instructions that, when executed by the second network node, cause the second network node to: transmit, to the first network node, a request for a list of sub-cells associated with the first network node.

Clause 118. The non-transitory computer-readable medium of any of clauses 106 to 117, wherein: the first network node is a Next Generation radio access network (NG-RAN) node, and the second network node is an access and mobility management function (AMF).

Clause 119. The non-transitory computer-readable medium of clause 118, wherein: the request is a Location Reporting Control message, and the location information report is a Location Report message.

Clause 120. The non-transitory computer-readable medium of any of clauses 106 to 117, wherein: the first network node is a base station distributed unit (DU), and the second network node is a base station central unit (CU).

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of communication performed by a first network node, comprising:
receiving, from a second network node, a request for location information for a user equipment (UE) served by the first network node; and
transmitting, to the second network node, a location information report for the UE, the location information report including at least an identifier of a sub-cell with which the UE is associated.

2. The method of claim 1, wherein the identifier of the sub-cell comprises:
an identifier of a cell portion within a cell associated with the UE,
an identifier of a transmission-reception point (TRP) serving the UE, or
an identifier of a repeater serving the UE.

3. The method of claim 1, wherein the request for location information indicates a requested sub-cell level of granularity, the requested sub-cell level of granularity comprising:
a cell portion within a cell associated with the UE,
a TRP serving the UE, or
a repeater serving the UE.

4. The method of claim 1, wherein the location information report includes time information associated with the identifier of the sub-cell.

5. The method of claim 1, wherein the location information report further includes:
a physical cell identifier (PCI) associated with the identifier of the sub-cell,
a New Radio cell global identifier (NCGI) associated with the identifier of the sub-cell,
an absolute radio-frequency channel number (ARFCN) associated with the identifier of the sub-cell,
a positioning reference signal (PRS) configuration associated with the identifier of the sub-cell,
synchronization signal block (SSB) information associated with the identifier of the sub-cell,
a system frame number (SFN) initialization time associated with the identifier of the sub-cell,
spatial direction information associated with the identifier of the sub-cell,
geographic coordinates associated with the identifier of the sub-cell, or any combination thereof.

6. The method of claim 1, further comprising:
receiving, from the second network node, one or more trigger conditions for transmitting the location information report.

7. The method of claim 6, wherein the one or more trigger conditions are associated with a set of TRPs, a set of repeaters, or a set of sub-cell identifiers.

8. The method of claim 7, wherein the one or more trigger conditions comprise;
whether the UE attached to or detached from a TRP in the set of TRPs or a repeater in the set of repeaters,
whether the UE is served by one or none of the set of TRPs or the set of repeaters,
or any combination thereof.

9. The method of claim 6, wherein the one or more trigger conditions are associated with one or more areas of interest associated with one or more sub-cells associated with the first network node.

10. The method of claim 9, wherein the one or more trigger conditions comprise:
whether the UE entered or exited the one or more areas of interest.

11. The method of claim 1, wherein the location information report is transmitted periodically.

12. The method of claim 1, further comprising:
receiving, from the second network node, a request for a list of sub-cells associated with the first network node.

13. The method of claim 1, wherein:
the first network node is a Next Generation radio access network (NG-RAN) node, and
the second network node is an access and mobility management function (AMF).

14. The method of claim 13, wherein:
the request is a Location Reporting Control message, and
the location information report is a Location Report message.

15. The method of claim 1, wherein:
the first network node is a base station distributed unit (DU), and
the second network node is a base station central unit (CU).

16. A method of communication performed by a second network node, comprising:
transmitting, to a first network node, a request for location information for a user equipment (UE) served by the first network node; and
receiving, from the first network node, a location information report for the UE, the location information report including at least an identifier of a sub-cell with which the UE is associated.

17. The method of claim 16, wherein the identifier of the sub-cell comprises:
an identifier of a cell portion within a cell associated with the UE,
an identifier of a transmission-reception point (TRP) serving the UE, or
an identifier of a repeater serving the UE.

18. The method of claim 16, wherein the request for location information indicates a requested sub-cell level of granularity, the requested sub-cell level of granularity comprising:
a cell portion within a cell associated with the UE,
a TRP serving the UE, or
a repeater serving the UE.

19. The method of claim 16, wherein the location information report includes time information associated with the identifier of the sub-cell.

20. The method of claim 16, wherein the location information report further includes:
a physical cell identifier (PCI) associated with the identifier of the sub-cell,
a New Radio cell global identifier (NCGI) associated with the identifier of the sub-cell,
an absolute radio-frequency channel number (ARFCN) associated with the identifier of the sub-cell,
a positioning reference signal (PRS) configuration associated with the identifier of the sub-cell,
synchronization signal block (SSB) information associated with the identifier of the sub-cell,
a system frame number (SFN) initialization time associated with the identifier of the sub-cell,
spatial direction information associated with the identifier of the sub-cell,
geographic coordinates associated with the identifier of the sub-cell, or
any combination thereof.

21. The method of claim 16, further comprising:
transmitting, to the first network node, one or more trigger conditions for transmitting the location information report.

22. The method of claim 21, wherein the one or more trigger conditions are associated with a set of TRPs, a set of repeaters, or a set of sub-cell identifiers.

23. The method of claim 22, wherein the one or more trigger conditions comprise:
whether the UE attached to or detached from a TRP in the set of TRPs or a repeater in the set of repeaters,
whether the UE is served by one or none of the set of TRPs or the set of repeaters,
or any combination thereof.

24. The method of claim 21, wherein the one or more trigger conditions are associated with one or more areas of interest associated with one or more sub-cells associated with the first network node.

25. The method of claim 24, wherein the one or more trigger conditions comprise:
whether the UE entered or exited the one or more areas of interest.

26. The method of claim 16, wherein the location information report is received periodically.

27. The method of claim 16, further comprising:
transmitting, to the first network node, a request for a list of sub-cells associated with the first network node.

28. The method of claim 16, wherein:
the first network node is a Next Generation radio access network (NG-RAN) node, and
the second network node is an access and mobility management function (AMF).

29. The method of claim 28, wherein:
the request is a Location Reporting Control message, and
the location information report is a Location Report message.

30. The method of claim 16, wherein:
the first network node is a base station distributed unit (DU), and
the second network node is a base station central unit (CU).

31. A first network node, comprising:
a memory;
at least one transceiver; and
at least one processor communicatively coupled to the memory and the at least one transceiver, the at least one processor configured to:
receive, via the at least one transceiver, from a second network node, a request for location information for a user equipment (UE) served by the first network node; and
transmit, via the at least one transceiver, to the second network node, a location information report for the UE, the location information report including at least an identifier of a sub-cell with which the UE is associated.

32. The first network node of claim 31, wherein the identifier of the sub-cell comprises:
an identifier of a cell portion within a cell associated with the UE,
an identifier of a transmission-reception point (TRP) serving the UE, or
an identifier of a repeater serving the UE.

33. The first network node of claim 31, wherein the request for location information indicates a requested sub-cell level of granularity, the requested sub-cell level of granularity comprising:
a cell portion within a cell associated with the UE,
a TRP serving the UE, or
a repeater serving the UE.

34. The first network node of claim 31, wherein the location information report includes time information associated with the identifier of the sub-cell.

35. The first network node of claim 31, wherein the location information report further includes:
a physical cell identifier (PCI) associated with the identifier of the sub-cell,
a New Radio cell global identifier (NCGI) associated with the identifier of the sub-cell,
an absolute radio-frequency channel number (ARFCN) associated with the identifier of the sub-cell,
a positioning reference signal (PRS) configuration associated with the identifier of the sub-cell,
synchronization signal block (SSB) information associated with the identifier of the sub-cell,
a system frame number (SFN) initialization time associated with the identifier of the sub-cell,
spatial direction information associated with the identifier of the sub-cell,
geographic coordinates associated with the identifier of the sub-cell, or
any combination thereof.

36. The first network node of claim 31, wherein the at least one processor is further configured to:
receive, via the at least one transceiver, from the second network node, one or more trigger conditions for transmitting the location information report.

37. The first network node of claim 36, wherein the one or more trigger conditions are associated with a set of TRPs, a set of repeaters, or a set of sub-cell identifiers.

38. The first network node of claim 37, wherein the one or more trigger conditions comprise:
whether the UE attached to or detached from a TRP in the set of TRPs or a repeater in the set of repeaters,
whether the UE is served by one or none of the set of TRPs or the set of repeaters,
or any combination thereof.

39. The first network node of claim 36, wherein the one or more trigger conditions are associated with one or more areas of interest associated with one or more sub-cells associated with the first network node.

40. The first network node of claim 39, wherein the one or more trigger conditions comprise:
whether the UE entered or exited the one or more areas of interest.

41. The first network node of claim 31, wherein the location information report is transmitted periodically.

42. The first network node of claim 31, wherein the at least one processor is further configured to:
receive, via the at least one transceiver, from the second network node, a request for a list of sub-cells associated with the first network node.

43. The first network node of claim 31, wherein:
the first network node is a Next Generation radio access network (NG-RAN) node, and
the second network node is an access and mobility management function (AMF).

44. The first network node of claim 43, wherein:
the request is a Location Reporting Control message, and
the location information report is a Location Report message.

45. The first network node of claim 31, wherein:
the first network node is a base station distributed unit (DU), and
the second network node is a base station central unit (CU).

46. A second network node, comprising:
a memory;
at least one transceiver; and
at least one processor communicatively coupled to the memory and the at least one transceiver, the at least one processor configured to:
transmit, via the at least one transceiver, to a first network node, a request for location information for a user equipment (UE) served by the first network node; and
receive, via the at least one transceiver, from the first network node, a location information report for the UE, the location information report including at least an identifier of a sub-cell with which the UE is associated.

47. The second network node of claim 46, wherein the identifier of the sub-cell comprises:
an identifier of a cell portion within a cell associated with the UE,
an identifier of a transmission-reception point (TRP) serving the UE, or
an identifier of a repeater serving the UE.

48. The second network node of claim 46, wherein the request for location information indicates a requested sub-cell level of granularity, the requested sub-cell level of granularity comprising:
a cell portion within a cell associated with the UE,
a TRP serving the UE, or
a repeater serving the UE.

49. The second network node of claim 46, wherein the location information report includes time information associated with the identifier of the sub-cell.

50. The second network node of claim 46, wherein the location information report further includes:
a physical cell identifier (PCI) associated with the identifier of the sub-cell,
a New Radio cell global identifier (NCGI) associated with the identifier of the sub-cell,
an absolute radio-frequency channel number (ARFCN) associated with the identifier of the sub-cell,
a positioning reference signal (PRS) configuration associated with the identifier of the sub-cell,
synchronization signal block (SSB) information associated with the identifier of the sub-cell,
a system frame number (SFN) initialization time associated with the identifier of the sub-cell,
spatial direction information associated with the identifier of the sub-cell,
geographic coordinates associated with the identifier of the sub-cell, or
any combination thereof.

51. The second network node of claim 46, wherein the at least one processor is further configured to:
transmit, via the at least one transceiver, to the first network node, one or more trigger conditions for transmitting the location information report.

52. The second network node of claim 51, wherein the one or more trigger conditions are associated with a set of TRPs, a set of repeaters, or a set of sub-cell identifiers.

53. The second network node of claim 52, wherein the one or more trigger conditions comprise:
whether the UE attached to or detached from a TRP in the set of TRPs or a repeater in the set of repeaters,
whether the UE is served by one or none of the set of TRPs or the set of repeaters,
or any combination thereof.

54. The second network node of claim 51, wherein the one or more trigger conditions are associated with one or more areas of interest associated with one or more sub-cells associated with the first network node.

55. The second network node of claim 54, wherein the one or more trigger conditions comprise:
whether the UE entered or exited the one or more areas of interest.

56. The second network node of claim 46, wherein the location information report is received periodically.

57. The second network node of claim 46, wherein the at least one processor is further configured to:
transmit, via the at least one transceiver, to the first network node, a request for a list of sub-cells associated with the first network node.

58. The second network node of claim 46, wherein:
the first network node is a Next Generation radio access network (NG-RAN) node, and
the second network node is an access and mobility management function (AMF).

59. The second network node of claim 58, wherein:
the request is a Location Reporting Control message, and
the location information report is a Location Report message.

60. The second network node of claim 46, wherein:
the first network node is a base station distributed unit (DU), and
the second network node is a base station central unit (CU).

61. A first network node, comprising:
means for receiving, from a second network node, a request for location information for a user equipment (UE) served by the first network node; and
means for transmitting, to the second network node, a location information report for the UE, the location information report including at least an identifier of a sub-cell with which the UE is associated.

62. A second network node, comprising:
means for transmitting, to a first network node, a request for location information for a user equipment (UE) served by the first network node; and
means for receiving, from the first network node, a location information report for the UE, the location information report including at least an identifier of a sub-cell with which the UE is associated.

63. A non-transitory computer-readable medium storing computer-executable instructions that, when executed by a first network node, cause the first network node to:
receive, from a second network node, a request for location information for a user equipment (UE) served by the first network node; and
transmit, to the second network node, a location information report for the UE, the location information report including at least an identifier of a sub-cell with which the UE is associated.

64. A non-transitory computer-readable medium storing computer-executable instructions that, when executed by a second network node, cause the second network node to:
transmit, to a first network node, a request for location information for a user equipment (UE) served by the first network node; and
receive, from the first network node, a location information report for the UE, the location information report including at least an identifier of a sub-cell with which the UE is associated.
